(19) United States
(12) Patent Application Publication
(10) Pub. No.: US 2007/0220131 A1
(43) Pub. Date: Sep. 20, 2007

(54) Apparatus and method for field device management

(75) Inventors: Hideki Ozawa, Musashino-shi (JP); Isao Hirooka, Musashino-shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/716,340

(22) Filed: Mar. 8, 2007

(30) Foreign Application Priority Data
Mar. 14, 2006 (JP) 2006-068545

(51) Int. Cl. G06F 15/173

(52) U.S. Cl. 709/223

(57) ABSTRACT

A correspondence storing section stores correspondence between a device type of a field device and an information processing algorithm conforming to the device type. A device type obtaining section obtains a device type of the field device from the field device. An algorithm selecting section specifies the algorithm corresponding to the device type obtained by the device type obtaining section based on the correspondence stored in the correspondence storing section, and selects the specified algorithm as an algorithm to be used for the field device.

This application claims foreign priority based on Japanese Patent application No. 2006-068545, filed Mar. 14, 2006, the content of which is incorporated herein by reference in its entirety.

### BACKGROUND OF THE INVENTION

1. Field of the Invention

The present invention relates to a field device management apparatus and a field device management method for providing information processing algorithms conforming to respective field devices.

2. Description of the Related Art

A field device management apparatus is known which performs information processing such as a display of information held by the field device, setting of various kinds of parameters of the field device and maintenance of the field device by performing communication with the field devices installed in a plant.

JP-A-2003-316424 describes a device diagnosing apparatus which diagnoses various kinds of field devices distributed in a plant by applying different kinds of diagnosis software, respectively.

The field device management apparatus provides a man-machine interface to a user by using a GUI (Graphic User Interface) component called as DTM (Device Type Manager). DTM is prepared for each type of the field devices, and the DTMs conforming to the field devices are used.

FIG. 4 is a block diagram showing a configuration of a field device management apparatus of a related art. As shown in FIG. 4, the field device management apparatus of the related art includes a DTM selecting section 51 for selecting a DTM conforming to a field device 2, and an information processing section 52 for executing various kinds of information processing related to the management of the field devices 2.

A user prepares a table 54 for defining the correspondence between the field devices 2 and the DTMs in advance. The table 54 defines the DTMs respectively conforming to the field devices 2 installed in a plant. The DTM selecting section 51 specifies, based on the table 54, the DTM corresponding to the field device 2 desired to communicate via a communication driver 3. Further, the DTM selecting section 51 reads the specified DTM from a stored DTM group 53 and supplies the specified DTM to the information processing section 52. The information processing section 52 executes the information processing related to the field device 2 by using the supplied DTM.

However, in the field device management apparatus of the related art, a user is required to define the correspondence with the DTM for each of the field devices 2 by the table 54 in advance, as for all the field devices 2 to be a communication target. Thus, the information processing can not be executed as to the field device 2 not being defined (having no correspondence) In this manner, since it is required to make the correspondence of the DTM for each of the field devices 2, the work becomes more complicated in accordance with the increase of the number of the field devices 2, and the working cost increases.

### SUMMARY OF THE INVENTION

The present invention has been made in view of the above circumstances, and provides a field device management apparatus and a field device management method which can obtain information processing algorithms conforming to respective field devices without complicated work.

In some implementations, a field device management apparatus of the invention comprising:

a correspondence storing section for storing correspondence between a device type of a field device and an information processing algorithm conforming to the device type;

a device type obtaining section for obtaining a device type of the field device from the field device; and

an algorithm selecting section for specifying the algorithm that corresponds to the device type which is obtained by the device type obtaining section, based on the correspondence stored in the correspondence storing section, and selecting the specified algorithm as an algorithm to be used for the field device

According to the field device management apparatus, since the necessary algorithm is selected by using the correspondence between the device type and the information processing algorithm conforming to the device type, the algorithm conforming to the field device can be obtained without complicated work.

In the field device management apparatus, the algorithm is defined by employing a device type manager.

The field device management apparatus further comprising:

an algorithm storing section for storing the algorithm; and

an information processing section for obtaining the algorithm selected by the algorithm selecting section from the algorithm storing section, and executing information processing related to the field device by using the obtained algorithm.

The field device management apparatus further comprising:

an installing section for storing the algorithm in an algorithm storing section, and simultaneously storing the correspondence of the algorithm in the correspondence storing section.

In some implementations, a field device management method of the invention comprising:

storing correspondence between a device type of a field device and an information processing algorithm conforming to the device type;

obtaining a device type of the field device from the field device; and

specifying the algorithm that corresponds to the obtained device type based on the stored correspondence, and selecting the specified algorithm as an algorithm to be used for the field device.

According to the field device management method, since the necessary algorithm is selected by using the correspondence between the device type and the information processing algorithm conforming to the device type, the algorithm conforming to the field device can be obtained without complicated work.

In the field device management method, the algorithm is defined by employing a device type manager.

The field device management method further comprising:

storing the algorithm; and

obtaining the selected algorithm from the stored algorithms, and executing information processing related to the field device by using the obtained algorithm.

The field device management method further comprising:

storing the algorithm, and simultaneously storing the correspondence of the algorithm.

### BRIEF DESCRIPTION OF THE DRAWINGS

FIG. 1 is a block diagram showing a configuration of a field device management apparatus according to an embodiment of the invention.

FIGS. 2A and 2B are diagrams showing configurations of tables stored in a correspondence storing section.

FIGS. 3A and 3B are flowcharts showing operation procedures of the field device management apparatus according to an embodiment of the invention.

FIG. 4 is a block diagram showing a configuration of a field device management apparatus of a related art.

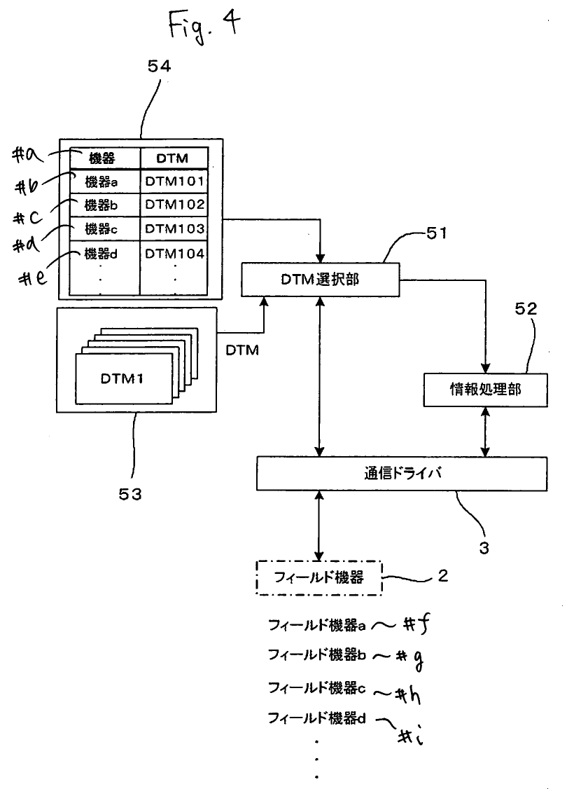

### DESCRIPTION OF THE PREFERRED EMBODIMENTS

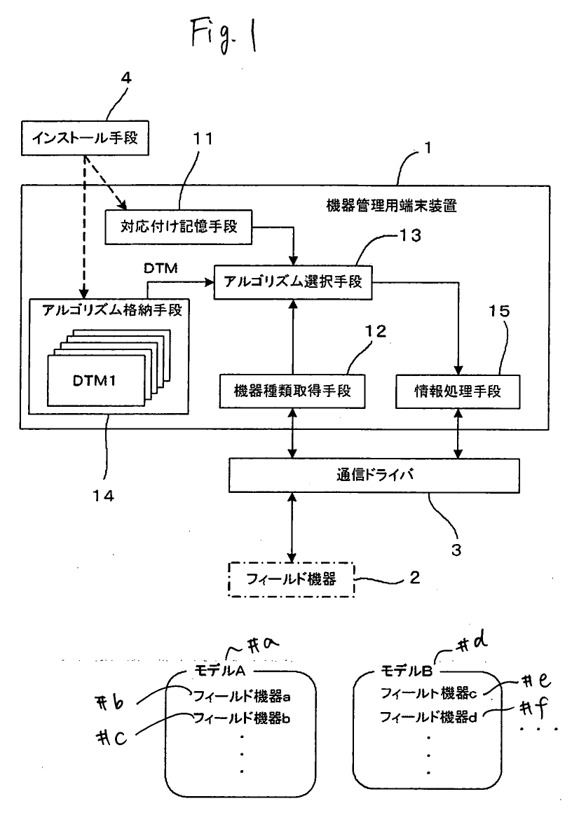

Hereinafter, a field device management apparatus according to an embodiment of the invention will be explained with reference to FIGS. 1 to 3B.

FIG. 1 is a block diagram showing a configuration of the field device management apparatus according to the embodiment.

As shown in FIG. 1, a device management terminal apparatus 1 includes: a correspondence storing section 11 for storing correspondence between device types of field devices 2 and information processing algorithms conforming to the device types, respectively; a device type obtaining section 12 for obtaining a device type of the field device 2 from the field device 2; an algorithm selecting section 13 for specifying the algorithm corresponding to the device type obtained by the device type obtaining section 12 based on the correspondence stored in the correspondence storing section 11 and selecting the specified algorithm as an algorithm to be used for the field device 2; an algorithm storing section 14 for storing the algorithms; and an information processing section 15 for obtaining the algorithm selected by the algorithm selecting section 13 from the algorithm storing section 14 and executing information processing related to the field device 2 by using the obtained algorithm.

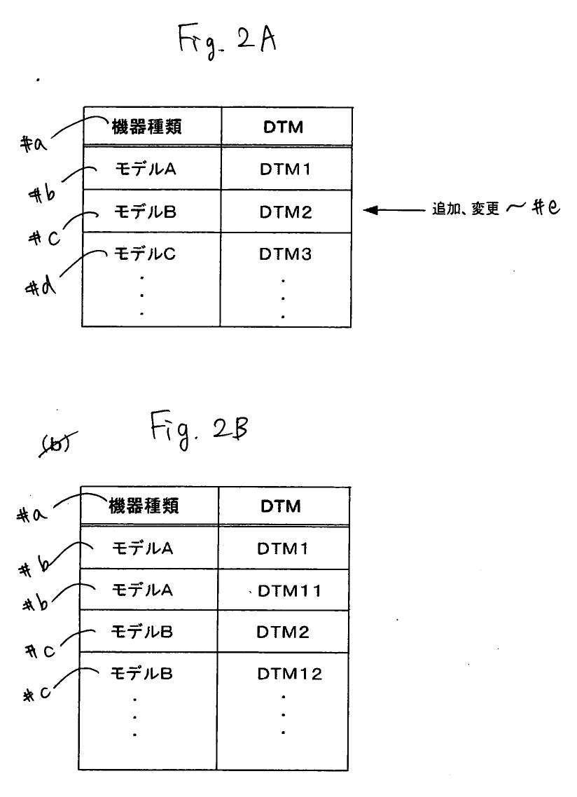

FIG. 2A is a diagram showing a configuration of a table stored in the correspondence storing section 11. As shown in FIG. 2A, the table has the correspondence between the device types of the field devices 2 and DTMs (Device Type Managers) respectively used for the device types. The field device management apparatus according to the embodiment provides a man-machine interface to a user by using the DTM serving as a GUI (Graphic User Interface) component. Thus, when executing various kinds of processes related to the respective field devices 2, it is required to select the DTM conforming to the field device. When the correct DTM is used, a correct algorithm conforming to the field device 2 can be obtained.

As shown in FIG. 1, the algorithm storing section 14 stores therein a plurality of the DTMs showing algorithms conforming to the device types of the field devices 2, respectively.

As shown in FIG. 1, the device type obtaining section 12 and the information processing section 15 can communicate with the field devices 2 via a communication driver 3.

As shown in FIG. 1, the field devices 2 installed in a plant are of a plurality of the device types. For example, “field device a,” “field device b,” etc., belong to “model A” of the same device type, and “field device c,” “field device d,” etc., belong to “model B” of the same device type.

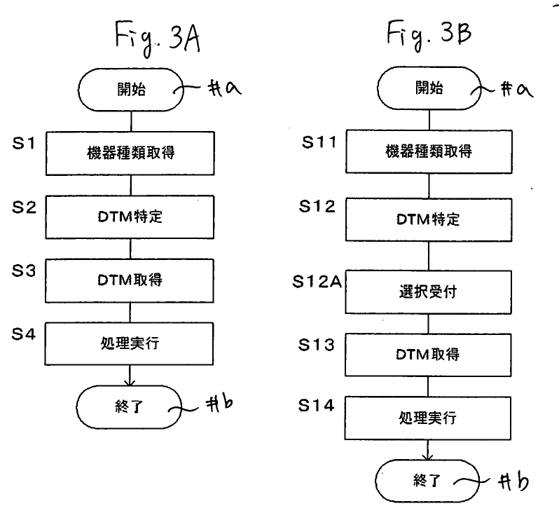

Steps S1 to S4 in FIG. 3A are a flowchart showing the operation procedure at the time of specifying the DTM and executing the predetermined information processing in the field device management apparatus according to the embodiment.

In step S1 of FIG. 3, the device type obtaining section 12 communicates with the predetermined field device 2 via the communication driver 3 and obtains the device type possessed by the field device 2. For example, when the field device 2 is the “field device a”, the device type of the field device is the “model A” as shown in FIG. 1. In this case, in this step S1, the “model A” is obtained as the device type from the field device 2. The device type thus obtained is supplied to the algorithm selecting section 13.

Next, in step S2, the algorithm selecting section 13 searches the table (FIG. 2A) in the correspondence storing section 11 based on the device type obtained in step S1, and specifies the DTM corresponding to the device type. For example, when the device type is the “model A”, “DTM1” is specified as the DTM corresponding to the “model A”.

Next, in step S3, the algorithm selecting section 13 obtains the DTM specified in step S2 from the algorithm storing section 14 and supplies the DTM to the information processing section 15.

Next, in step S4, the information processing section 15 executes the predetermined information processing by using the DTM thus obtained, thereby to complete a series of the procedures. In step S4, the information processing section 15 executes the information processing such as the display of information held by the field device 2, the setting of various kinds of parameters of the field device and the maintenance of the field device 2. For example, the information processing section 15 executes the screen display as for the field device 2 as the communication target thereby to provide the information of the field device 2 to a user, and further accepts operations from the user. Further, the information processing section 15 executes the processing such as the setting of the respective parameters for the field device 2 according to the operations from the user. The information processing section 15 suitably executes the communication with the field device 2 via the communication driver 3.

In the field device management apparatus according to the embodiment, in a case of installing a software program for managing the field devices into the device management terminal apparatus 1, an installing section 4 simultaneously executes the storing of the DTM group in the algorithm storing section 14 and the storing of the table (FIG. 2A) in the correspondence storing section 11. Thus, a user is not required to do the work of making the correspondence between field devices and the DTMs having been performed in the related art.

Further, in the field device management apparatus according to the embodiment, since the device type of the field device 2 to be the information processing target is obtained and the DTM corresponding to the device type is selected, it is not necessary to make the correspondence directly between each of the field devices 2 and the DTM. In usual, a plant has a plurality of field devices of the same device type, and the number of the device types is smaller compared to the total number of the devices. Thus, even in a case where a user prepares the table (FIG. 2A) to define the correspondence, the user is merely required to make the correspondence between the device types and the DTMs, respectively, whereby the working cost can be largely reduced as compared with the work of making the correspondence for the respective field devices having been performed in the related art.

In such a case of introducing a new field device in a plant, the installing section 4 adds a correspondence concerning a device type required to be added, to the table (FIG. 2A) in the correspondence storing section 11. Further, the installing section 4 additively stores a DTM corresponding to the added device type in the algorithm storing section 14 simultaneously with the addition of the correspondence. Similarly, when the correspondence of the table (FIG. 2A) in the correspondence storing section 11 is required to be changed, the installing section 4 changes the correspondence of the table. Further, the installing section 4 additively stores a DTM required by the change in the algorithm storing section 14 simultaneously with the change of the correspondence.

For example, when the “model B” is added as the device type of the field device or when the correspondence concerning the “model B” is changed, a section of “model B” is added in the table or changed as shown in FIG. 2A. Further, simultaneously, “DTM2” corresponding to the “model B” is additively stored in the algorithm storing section 14.

The aforesaid processing by the installing section 4 can be executed by previously preparing a wide database (a table for correspondence between the device types and the DTMs) for the correspondence required for preparing, adding and changing the table, and introducing necessary data from the database into the correspondence storing section 11 and the algorithm storing section 14. The correspondence storing section 11 and the algorithm storing section 14 may store therein the table and the DTMs in ranges required at the current time point, respectively. Thus, at the time of setting up a plant or adding or changing the field device 2, etc., a user can be made free from the complicated work for preparing a required DTM and the table (FIG. 2A), or for confirming the matching between the table (FIG. 2A) and the stored DTMs.

As shown in FIG. 2B, the table in the correspondence storing section 11 may be arranged to make correspondence between a plurality of DTMs and one kind of the device type. For example, in a case where there are a DTM used normally and another DTM used at the time of adjusting the field device as to the same device type, two DTMs may be made to correspond with one kind of the device type. In an example of FIG. 2B, “model A” is made to correspond with “DTM1” and “DTM11”, and “model B” is made to correspond with “DTM2” and “DTM12”.

Steps S11 to S14 of FIG. 3B are a flowchart showing the operation procedure at the time of selecting a predetermined DTM from a plurality of DTMs and executing the predetermined information processing.

In step S11 of FIG. 3B, the device type obtaining section 12 communicates with the predetermined field device 2 via the communication driver 3 and obtains the device type possessed by the field device 2. For example, when the field device 2 is “field device a”, the device type of the field device is “model A” as shown in FIG. 1. In this case, in this step S1, “model A” is obtained as the device type from the field device 2. The device type thus obtained is supplied to the algorithm selecting section 13.

Next, in step S12, the algorithm selecting section 13 searches the table (FIG. 2B) in the correspondence storing section 11 based on the device type obtained in step S11, and specifies a plurality of the DTMs corresponding to the device type. For example, when the device type is “model A”, “DTM1” and “DTM11” are specified as the DTMs corresponding to the “model A”.

Next, in step S12A, the computer 1 (device management terminal apparatus 1) receives an instruction from a user thereby to select one DTM from a plurality of the DTMs. For example, “DTM11” is selected when the field device 2 is under the inspection, whilst “DTM1” is selected in the normal state.

Next, in step S13, the algorithm selecting section 13 obtains the DTMs elected in step S12 from the algorithm storing section 14 and supplies the DTM to the information processing section 15.

Next, in step S14, the information processing section 15 executes the predetermined information processing by using the DTM thus obtained, thereby to complete a series of the procedures.

In this manner, even in the case where a plurality of the DTMs are made to correspond with one kind of the device type, a suitable DTM can be selected in accordance with a circumstance.

As described above, according to the field device management apparatus of the invention, since the necessary algorithm can be selected by using the correspondence between the device types and the information processing algorithms conforming to the device types, the algorithm conforming to the field device can be obtained without complicated work. Further, since the installing section 4 is provided, complicated work for making the correspondence between the device types and the DTMs and for storing the DTMs can be eliminated.

The applicable field of the invention is not limited to the aforesaid embodiment. The invention can be applied widely to a case of providing information processing algorithms conforming to the respective field devices in the management of the devices.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A field device management apparatus, comprising:
a correspondence storing section for storing correspondence between a device type of a field device and an information processing algorithm conforming to the device type;
a device type obtaining section for obtaining a device type of the field device from the field device; and
an algorithm selecting section for specifying the algorithm that corresponds to the device type which is obtained by the device type obtaining section, based on the correspondence stored in the correspondence storing section, and selecting the specified algorithm as an algorithm to be used for the field device.

2. The field device management apparatus according to claim 1, wherein the algorithm is defined by employing a device type manager.

3. The field device management apparatus according to claim 1, further comprising:
an algorithm storing section for storing the algorithm; and
an information processing section for obtaining the algorithm selected by the algorithm selecting section from the algorithm storing section, and executing information processing related to the field device by using the obtained algorithm.

4. The field device management apparatus according to claim 1, further comprising:
an installing section for storing the algorithm in an algorithm storing section, and simultaneously storing the correspondence of the algorithm in the correspondence storing section.

5. A field device management method, comprising:
storing correspondence between a device type of a field device and an information processing algorithm conforming to the device type;
obtaining a device type of the field device from the field device; and
specifying the algorithm that corresponds to the obtained device type based on the stored correspondence, and selecting the specified algorithm as an algorithm to be used for the field device.

6. The field device management method according to claim 5, wherein the algorithm is defined by employing a device type manager.

7. The field device management method according to claim 5, further comprising:
storing the algorithm; and
obtaining the selected algorithm from the stored algorithms, and executing information processing related to the field device by using the obtained algorithm.

8. The field device management method according to claim 5, further comprising:
storing the algorithm, and simultaneously storing the correspondence of the algorithm.
